(19) United States
(12) Patent Application Publication
(10) Pub. No.: US 2021/0318782 A1
(43) Pub. Date: Oct. 14, 2021

(54) APPARATUS INTEGRATED WITH FINGERPRINT RECOGNITION AND TOUCH DETECTION

(71) Applicant: HIMAX TECHNOLOGIES LIMITED, Tainan City (TW)

(72) Inventors: Jia-Ming HE, Tainan City (TW); Yaw-Guang CHANG, Tainan City (TW)

(21) Appl. No.: 16/984,108

(22) Filed: Aug. 3, 2020

Related U.S. Application Data
(60) Provisional application No. 63/008,843, filed on Apr. 13, 2020.

(51) Int. Cl. G06F 3/044; G06F 3/0354; G06K 9/00

(52) U.S. Cl. CPC G06F 3/0448; G06K 9/00087; G06F 3/03547

(57) ABSTRACT

An apparatus integrated with fingerprint recognition and touch detection is provided. The apparatus includes a touchpad and a controller IC. The touchpad has a touch area for recognizing a touch event and a fingerprint area for recognizing a fingerprint and the touch event. The fingerprint area includes TX lines of a first group crossing RX lines of a first group. The touch area includes TX lines of the first group and a second group crossing RX lines of the first group and a second group. When the apparatus is operated in a fingerprint sensing mode, the controller IC supplies a driving signal to the TX lines of the first group. When the apparatus is operated in a touch sensing mode, the controller IC supplies the driving signal to the TX lines of the second group and a portion of the TX lines of the first group.

### RELATED APPLICATIONS

This application claims priority to U.S. Provisional Application Ser. No. 63/008,843, filed Apr. 13, 2020, which is herein incorporated by reference.

### BACKGROUND

### Field of Invention

The present invention relates to an apparatus integrated with fingerprint recognition and touch detection. More particularly, the present invention relates to an apparatus integrated with fingerprint recognition and touch detection for reducing sensed parasitic capacitance.

### Description of Related Art

Currently, secure computer systems, which require fingerprint authentication, utilize a separate pointer touchpad device for cursor control and a separate fingerprint recognition device for fingerprint authentication. Correspondingly, the use of two separate peripheral devices for two different functions (i.e., cursor control and fingerprint authentication) results in increased cost and complexity of operating a secure computer system. Correspondingly, as more and more computer systems are incorporating the use of separate fingerprint recognition devices, in order to provide for system security, the need to consolidate the fingerprint recognition devices into existing peripheral components grows as the demand for simplified single multi-functional devices increases.

### SUMMARY

The present invention provides an apparatus integrated with fingerprint recognition and touch detection. The apparatus includes a touchpad and a controller integrated circuit (IC). The touchpad has a touch area for recognizing a touch event and a fingerprint area for recognizing a fingerprint and the touch event. The fingerprint area includes first receive (RX) lines crossing first transmit (TX) lines. The touch area includes second RX lines crossing the first TX lines and second TX lines. Each of the first RX lines extends from the controller IC across the fingerprint area and terminates at a first edge of the fingerprint area.

In accordance with one or more embodiments of the invention, a distance between adjacent ones of the first TX lines is smaller than a distance between adjacent ones of the second TX lines. A distance between adjacent ones of the first RX lines is smaller than a distance between adjacent ones of the second RX lines.

In accordance with one or more embodiments of the invention, the fingerprint area further includes a portion of the second RX lines crossing the first TX lines. Each of the second RX lines included in the fingerprint area is arranged between adjacent ones of the first RX lines.

In accordance with one or more embodiments of the invention, when the apparatus is operated in a touch sensing mode, the controller IC supplies a driving signal to the second TX lines and a portion of the first TX lines, such that the touch event is recognized according to changes in capacitance sensed through the second RX lines. A distance between adjacent ones of the first TX lines which belong to the portion of the first TX lines is the same as a distance between adjacent ones of the second TX lines.

In accordance with one or more embodiments of the invention, when the apparatus is operated in a fingerprint sensing mode, the controller IC supplies a driving signal to the first TX lines, such that the fingerprint is recognized according to changes in capacitance sensed through the first RX lines.

In accordance with one or more embodiments of the invention, when the apparatus is operated in a fingerprint sensing mode, the controller IC supplies a driving signal to the first TX lines, such that the fingerprint is recognized according to changes in capacitance sensed through the second RX lines included in the fingerprint area and the first RX lines.

In accordance with one or more embodiments of the invention, a portion of the second RX lines extends from the controller IC across the touch area along the first edge, a second edge, and a third edge of the fingerprint area and terminates at an edge of the touch area. The second edge and the third edge of the fingerprint area are perpendicular to the first edge of the fingerprint area.

In accordance with one or more embodiments of the invention, when the apparatus is operated in a touch sensing mode, the controller IC supplies a driving signal to the second TX lines and a portion of the first TX lines, such that the touch event is recognized according to changes in capacitance sensed through the second RX lines and a portion of the first RX lines. A distance between adjacent ones of the first TX lines which belong to the portion of the first TX lines is the same as a distance between adjacent ones of the second TX lines. A distance between adjacent ones of the first RX lines which belong to the portion of the first RX lines is the same as a distance between adjacent ones of the second RX lines which do not belong to the portion of the second RX lines.

In accordance with one or more embodiments of the invention, when the apparatus is operated in a fingerprint sensing mode, the controller IC supplies a driving signal to the first TX lines, such that the fingerprint is recognized according to changes in capacitance sensed through the first RX lines.

In accordance with one or more embodiments of the invention, the fingerprint area is located at a middle of the touch pad. The touch area further includes the first RX lines crossing some of the second TX lines.

The present invention further provides an apparatus integrated with fingerprint recognition and touch detection. The apparatus includes a touchpad and a controller integrated circuit (IC). The touchpad has a touch area for recognizing a touch event and a fingerprint area for recognizing a fingerprint and the touch event. The fingerprint area includes first receive (RX) lines crossing first transmit (TX) lines. The touch area includes second RX lines crossing second TX lines. Each of the first RX lines extends from the controller IC across the fingerprint area and terminates at a first edge of the fingerprint area. Each of the first TX lines extends from the controller IC across the fingerprint area and terminates at a second edge of the fingerprint area.

In accordance with one or more embodiments of the invention, the fingerprint area is located at a corner of the touch pad.

In accordance with one or more embodiments of the invention, a distance between adjacent ones of the first TX lines is smaller than a distance between adjacent ones of the second TX lines. A distance between adjacent ones of the first RX lines is smaller than a distance between adjacent ones of the second RX lines.

In accordance with one or more embodiments of the invention, the fingerprint area further includes a portion of the second RX lines crossing the first TX lines. Each of the second RX lines included in the fingerprint area is arranged between adjacent ones of the first RX lines.

In accordance with one or more embodiments of the invention, when the apparatus is operated in a touch sensing mode, the controller IC supplies a driving signal to the second TX lines and a portion of the first TX lines, such that the touch event is recognized according to changes in capacitance sensed through the second RX lines. A distance between adjacent ones of the first TX lines which belong to the portion of the first TX lines is the same as a distance between adjacent ones of the second TX lines.

In accordance with one or more embodiments of the invention, when the apparatus is operated in a fingerprint sensing mode, the controller IC supplies a driving signal to the first TX lines, such that the fingerprint is recognized according to changes in capacitance sensed through the first RX lines.

In accordance with one or more embodiments of the invention, when the apparatus is operated in a fingerprint sensing mode, the controller IC supplies a driving signal to the first TX lines, such that the fingerprint is recognized according to changes in capacitance sensed through the second RX lines included in the fingerprint area and the first RX lines.

In accordance with one or more embodiments of the invention, a portion of the second RX lines extends from the controller IC across the touch area along the first edge and the second edge of the fingerprint area and terminates at an edge of the touch area. The first edge of the fingerprint area is perpendicular to the second edge of the fingerprint area.

In accordance with one or more embodiments of the invention, when the apparatus is operated in a touch sensing mode, the controller IC supplies a driving signal to the second TX lines and a portion of the first TX lines, such that the touch event is recognized according to changes in capacitance sensed through the second RX lines and a portion of the first RX lines. A distance between adjacent ones of the first TX lines which belong to the portion of the first TX lines is the same as a distance between adjacent ones of the second TX lines. A distance between adjacent ones of the first RX lines which belong to the portion of the first RX lines is the same as a distance between adjacent ones of the second RX lines which do not belong to the portion of the second RX lines.

In accordance with one or more embodiments of the invention, wherein when the apparatus is operated in a fingerprint sensing mode, the controller IC supplies a driving signal to the first TX lines, such that the fingerprint is recognized according to changes in capacitance sensed through the first RX lines.

### BRIEF DESCRIPTION OF THE DRAWINGS

The invention can be more fully understood by reading the following detailed description of the embodiment, with reference made to the accompanying drawings as follows:

FIG. 1 illustrates a block diagram of apparatus integrated with fingerprint recognition and touch detection according to some embodiments of the present invention.

FIG. 2 illustrates a plan view of a layout of the touch area and the fingerprint area of the touchpad of the apparatus according to a first embodiment of the present invention.

FIG. 3 illustrates a flow chart of a method of controlling the apparatus 100 according to the first embodiment of the present invention.

FIG. 4 illustrates a plan view of a layout of the touch area and the fingerprint area of the touchpad of the apparatus according to a second embodiment of the present invention.

FIG. 5 illustrates a plan view of a layout of the touch area and the fingerprint area of the touchpad of the apparatus according to a third embodiment of the present invention.

FIG. 6 illustrates a plan view of a layout of the touch area and the fingerprint area of the touchpad of the apparatus according to a fourth embodiment of the present invention.

FIG. 7 illustrates a plan view of a layout of the touch area and the fingerprint area of the touchpad of the apparatus according to a fifth embodiment of the present invention.

FIG. 8 illustrates a plan view of a layout of the touch area and the fingerprint area of the touchpad of the apparatus according to a sixth embodiment of the present invention.

FIG. 9 illustrates a plan view of a layout of the touch area and the fingerprint area of the touchpad of the apparatus according to a seventh embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size. The using of “first”, “second”, “third”, etc. in the specification should be understood for identify units or data described by the same terminology, but are not referred to particular order or sequence.

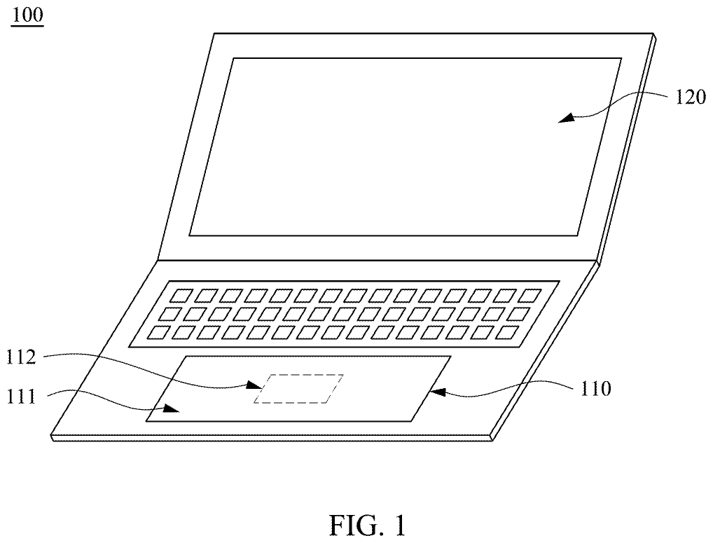

FIG. 1 illustrates a block diagram of apparatus 100 integrated with fingerprint recognition and touch detection according to some embodiments of the present invention. The apparatus 100 includes a touchpad 110 and a display screen 120. The touchpad 110 has a touch area 111 and a fingerprint area 112 distinct from the touch area 111. The touch area 111 is used for recognizing a touch event and a fingerprint area. The fingerprint area 112 is used for recognizing a fingerprint and the touch event.

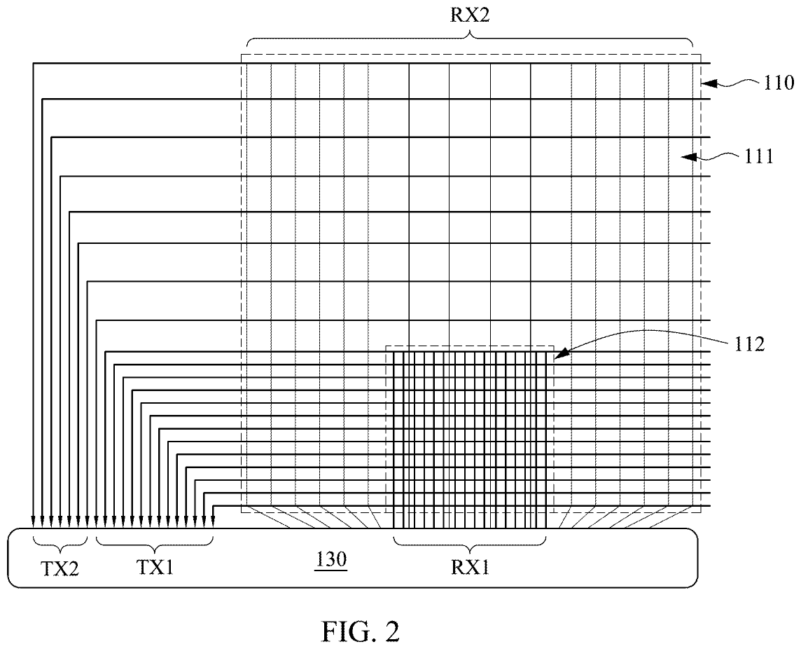

FIG. 2 illustrates a plan view of a layout of the touch area 111 and the fingerprint area 112 of the touchpad 110 of the apparatus 100 according to a first embodiment of the present invention.

The fingerprint area 112 distinct from the touch area 111 includes plural first transmit (TX) lines TX1 which are arranged in parallel with one another in a horizontal direction. The fingerprint area 112 further includes plural first receive (RX) lines RX1 which are arranged in parallel with one another in a vertical direction perpendicular to the horizontal direction. In the fingerprint area 112, the first TX lines TX1 cross the first RX lines RX1.

The touch area 111 distinct from the fingerprint area 112 includes plural second TX lines TX2 and the first TX lines TX1, in which the second TX lines TX2 are arranged in parallel with one another in the horizontal direction. The touch area 111 further includes plural second RX lines RX2 which are arranged in parallel with one another in the vertical direction. In the touch area 111, the first TX lines TX1 and the second TX lines TX2 cross the second RX lines RX2.

As shown in FIG. 2, the fingerprint area 112 further includes a portion of the second RX lines RX2 crossing the first TX lines TX1. Each of the second RX lines RX2 included in the fingerprint area 112 is arranged between two adjacent ones of the first RX lines RX1.

The touchpad 110 includes a plurality of sensors (not shown), each having a capacitance. The capacitance may be divided into a self-capacitance and a mutual capacitance. The self-capacitance may be formed along a conductor line of a single layer formed in one direction, and the mutual capacitance may be formed between two conductor lines perpendicular to each other. The sensors are respectively formed at crossing of the first TX lines TX1 and the first/second RX lines RX1/RX2 and at crossing of the second TX lines TX2 and the second RX lines RX2. It is noted that the number of the first/second TX lines TX1/TX2, the number of the first/second RX lines RX1/RX2, and the layout of the first/second TX lines TX1/TX2 and the first/second RX lines RX1/RX2 as shown in FIG. 2 are merely an example, and the present invention is not limited thereto.

The apparatus 100 further includes a controller integrated circuit (IC) 130. The controller IC 130 may supply a driving signal to the sensor through the first/second TX lines TX1/TX2, supply charges to the sensor, and sense changes in capacitance of the sensor through the corresponding RX lines (i.e., the first RX lines RX1 or the second RX lines RX2) in synchronization with the driving signal, thereby sensing a touch input.

In the first embodiment of the present invention, when the apparatus 100 is operated in a fingerprint sensing mode, the controller IC 130 supplies the driving signal to the first TX lines TX1, and senses a change in charges of the corresponding sensors input from the first RX lines RX1, and thus determines a fingerprint input, thereby sensing a fingerprint information.

In the first embodiment of the present invention, when the apparatus 100 is operated in a touch sensing mode, the controller IC 130 supplies the driving signal to the second TX lines TX2 and a portion of the first TX lines TX1, and senses a change in charges of the corresponding sensors input from the second RX lines RX2, and thus determines a touch input, thereby sensing a touch position.

As shown in FIG. 2, a distance between adjacent ones of the first TX lines TX1 is smaller than a distance between adjacent ones of the second TX lines TX2, and a distance between adjacent ones of the first RX lines RX1 is smaller than a distance between adjacent ones of the second RX lines RX2. In the first embodiment of the present invention, the first TX lines TX1 and the first RX lines RX1 are used for recognizing the fingerprint, and thus the distance between adjacent ones of the first TX lines TX1 and the distance between adjacent ones of the first RX lines RX1 may be about 50 μm. In the first embodiment of the present invention, the second TX lines TX2 and the second RX lines RX2 are used for recognizing the touch event as cursor control, and thus the distance between adjacent ones of the second TX lines TX2 and the distance between adjacent ones of the second RX lines RX2 may be about 1 mm to 5 mm.

Because the first TX lines TX1 and the first RX lines RX1 are formed as a high-density arrangement pattern, the corresponding sensors formed at crossing of the first TX lines TX1 and the first RX lines RX1 are minutely formed so that the corresponding sensors may be positioned between ridges and valleys of a fingerprint. Therefore, fingerprint recognition can be accurately performed. In contrast, because touch event recognition does not require a definition as high as that of fingerprint recognition, the second TX lines TX2 and the second RX lines RX2 are formed as a low-density arrangement pattern. Accordingly, because touch event recognition does not require a definition as high as that of fingerprint recognition, the portion of the first TX lines TX1 used for touch event recognition are selected from the first TX lines TX1, and the first TX lines TX1 which belong to the portion of the first TX lines TX1 used for touch event recognition are selected as the low-density arrangement pattern which is identical to the low-density arrangement pattern of the second TX lines TX2. In the first embodiments of the present invention, a distance between adjacent ones of the first TX lines TX1 which belong to the portion of the first TX lines TX1 is the same as a distance between adjacent ones of the second TX lines TX2.

It is worth mentioning that the widths and/or the patterns of the first/second TX lines TX1/TX2 and/or the first/second RX lines RX1/RX2 may be adjusted to enhance the amount of signal sensing by the corresponding sensor formed at crossing of the corresponding first/second TX lines TX1/TX2 and the corresponding first/second RX lines RX1/RX2. For example, the widths of the first/second TX lines TX1/TX2 and/or the first/second RX lines RX1/RX2 may be increased to enhance the amount of signal sensing by the corresponding sensor formed at crossing of the corresponding first/second TX lines TX1/TX2 and the corresponding first/second RX lines RX1/RX2. For example, the patterns of the first/second TX lines TX1/TX2 and/or the first/second RX lines RX1/RX2 may be adjusted (e.g., the branch pattern) to enhance the amount of signal sensing by the corresponding sensor formed at crossing of the corresponding first/second TX lines TX1/TX2 and the corresponding first/second RX lines RX1/RX2.

As shown in FIG. 2, the fingerprint area 112 is located at bottom middle part of the touchpad 110. As shown in FIG. 2, each of the first RX lines RX1 extends from the controller IC 130 across the fingerprint area 112 and terminates at an upper edge of the fingerprint area 112. Please note that if each of the first RX lines RX1 extends across entire of the touch area 111, a large parasitic capacitance and a large parasitic resistance will affect the sensed fingerprint information because the sensed signal of the fingerprint is relatively weak. In the first embodiment of the present invention, each of the first RX lines RX1 terminates at the upper edge of the fingerprint area 112 and does not extend upward to the touch area 111, such that a length of trace of each of the first RX lines RX1 used for recognizing the fingerprint is reduced, and thus the sensed parasitic capacitance and the sensed parasitic resistance generated by the first RX lines RX1 in the fingerprint area 112 are reduced, thereby preventing the sensed parasitic capacitance and the sensed parasitic resistance from affecting the sensed fingerprint information. Further, due to a length of trace of each of the first RX lines RX1 used for recognizing the fingerprint is reduced, the loading of the controller IC 130 for driving the fingerprint area 112 is also reduced.

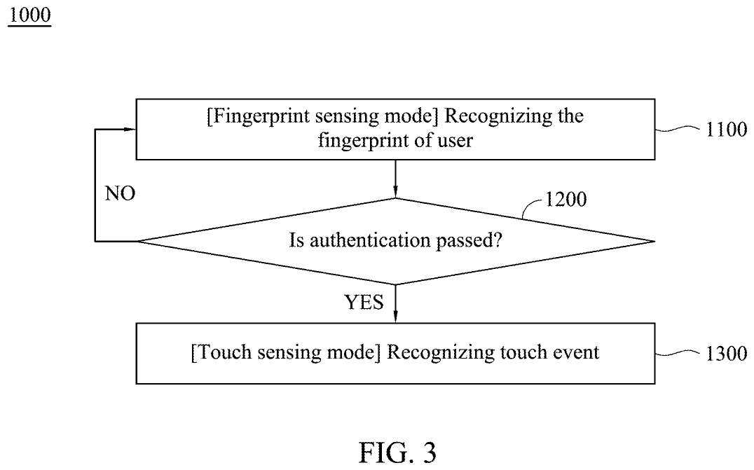

FIG. 3 illustrates a flow chart of a method 1000 of controlling the apparatus 100 according to the first embodiment of the present invention. In step 1100 of the method 1000, the apparatus 100 is operated in a fingerprint sensing mode so as to recognize a fingerprint of a user, thereby determining authentication of the user. Then, in step 1200 of the method 1000, the apparatus 100 determines whether authentication of the user is passed. When the authentication of the user is passed, the step 1300 is performed. When the authentication of the user is failed, the step 1200 is performed again to recognize the fingerprint of a user.

In step 1300 of the method 1000, the apparatus 100 is operated in the touch sensing mode so as to recognize the touch event, such that the apparatus 100 performs cursor control by recognizing the touch event.

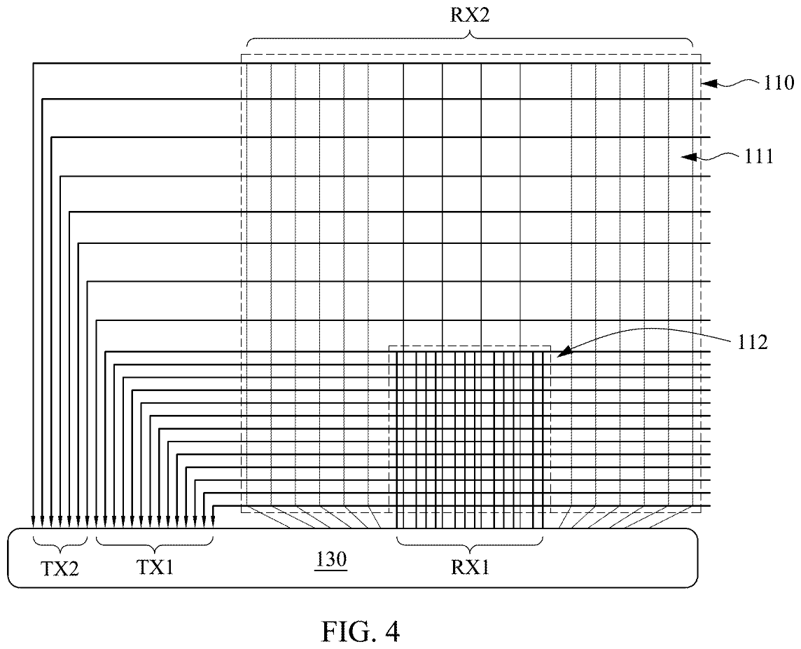

FIG. 4 illustrates a plan view of a layout of the touch area 111 and the fingerprint area 112 of the touchpad 110 of the apparatus 100 according to a second embodiment of the present invention.

The layout of the touch area 111 and the fingerprint area 112 as shown in FIG. 4 is similar to the layout of the touch area 111 and the fingerprint area 112 as shown in FIG. 2. However, in the second embodiment of the present invention, when the apparatus 100 is operated in a fingerprint sensing mode, the controller IC 130 supplies a driving signal to the first TX lines TX1, and senses a change in charges of the corresponding sensors input from the second RX lines RX2 included in the fingerprint area 112 and the first RX lines RX1, and thus determines a fingerprint input, thereby sensing a fingerprint information. That is, in the second embodiment of the present invention, the second RX lines RX2 included in the fingerprint area 112 and the first RX lines RX1 are used for recognizing the fingerprint.

As shown in FIG. 4, the fingerprint area 112 is located at bottom middle part of the touchpad 110. As shown in FIG. 4, each of the first RX lines RX1 extends from the controller IC 130 across the fingerprint area 112 and terminates at an upper edge of the fingerprint area 112. In the second embodiment of the present invention, each of the first RX lines RX1 terminates at the upper edge of the fingerprint area 112 and does not extend upward to the touch area 111, such that a length of trace of each of the first RX lines RX1 used for recognizing the fingerprint is reduced, and thus the sensed parasitic capacitance and the sensed parasitic resistance generated in the fingerprint area 112 are reduced, thereby preventing the sensed parasitic capacitance and the sensed parasitic resistance from affecting the sensed fingerprint information. Further, due to a length of trace of each of the first RX lines RX1 used for recognizing the fingerprint is reduced, the loading of the controller IC 130 for driving the fingerprint area 112 is also reduced.

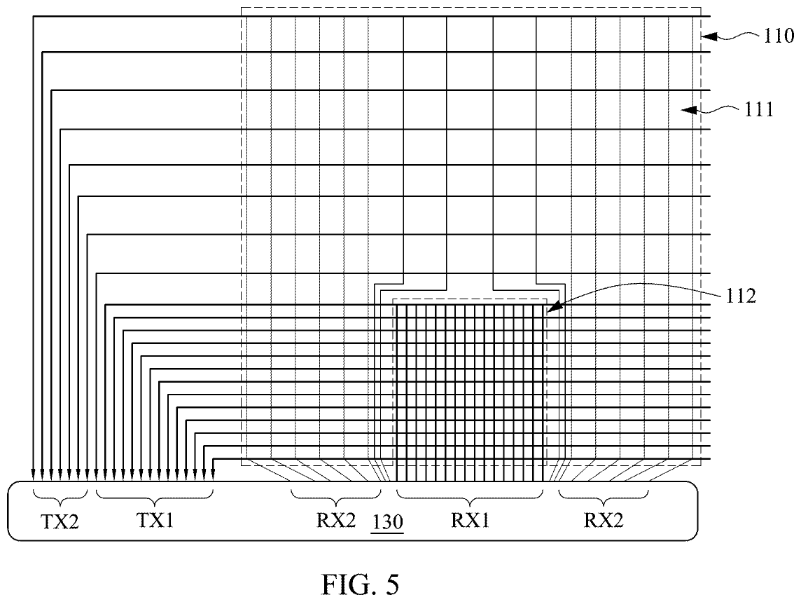

FIG. 5 illustrates a plan view of a layout of the touch area 111 and the fingerprint area 112 of the touchpad 110 of the apparatus 100 according to a third embodiment of the present invention.

The layout of the touch area 111 and the fingerprint area 112 as shown in FIG. 5 is similar to the layout of the touch area 111 and the fingerprint area 112 as shown in FIG. 2. However, in the third embodiment of the present invention, the fingerprint area 112 does not include any of the second RX lines RX2. Accordingly, each of the second RX lines RX2 of a portion of the second RX lines RX2 extends from the controller IC 130 across the touch area 111 along a left edge and the upper edge or along a right edge and the upper edge of the fingerprint area 112 and terminates at a upper edge of the touch area 111. The left edge and the right edge of the fingerprint area 112 are perpendicular to the upper edge of the fingerprint area 112.

In the third embodiment of the present invention, when the apparatus 100 is operated in a fingerprint sensing mode, the controller IC 130 supplies the driving signal to the first TX lines TX1, and senses a change in charges of the corresponding sensors input from the first RX lines RX1, and thus determines a fingerprint input, thereby sensing a fingerprint information.

In the third embodiment of the present invention, when the apparatus 100 is operated in a touch sensing mode, the controller IC 130 supplies a driving signal to the second TX lines TX2 and a portion of the first TX lines TX1, and senses a change in charges of the corresponding sensors input from the second RX lines RX2 and a portion of the first RX lines RX1, and thus determines a touch input, thereby sensing a touch position.

In the third embodiment of the present invention, because touch event recognition does not require a definition as high as that of fingerprint recognition, the portion of the first TX lines TX1 used for touch event recognition are selected from the first TX lines TX1, and the first TX lines TX1 which belong to the portion of the first TX lines TX1 used for touch event recognition are selected as the low-density arrangement pattern which is identical to the low-density arrangement pattern of the second TX lines TX2. In the third embodiment of the present invention, because touch event recognition does not require a definition as high as that of fingerprint recognition, the portion of the first RX lines RX1 used for touch event recognition are selected from the first RX lines RX1, and the first RX lines RX1 which belong to the portion of the first RX lines RX1 used for touch event recognition are selected as the low-density arrangement pattern which is identical to the low-density arrangement pattern of the second RX lines RX2. In the third embodiments of the present invention, a distance between adjacent ones of the first TX lines TX1 which belong to the portion of the first TX lines TX1 is the same as a distance between adjacent ones of the second TX lines TX2, and a distance between adjacent ones of the first RX lines RX1 which belong to the portion of the first RX lines RX1 is the same as a distance between adjacent ones of the second RX lines RX2.

As shown in FIG. 5, the fingerprint area 112 is located at bottom middle part of the touchpad 110. As shown in FIG. 5, each of the first RX lines RX1 extends from the controller IC 130 across the fingerprint area 112 and terminates at an upper edge of the fingerprint area 112. In the third embodiment of the present invention, each of the first RX lines RX1 terminates at the upper edge of the fingerprint area 112 and does not extend upward to the touch area 111, such that a length of trace of each of the first RX lines RX1 used for recognizing the fingerprint is reduced, and thus the sensed parasitic capacitance and the sensed parasitic resistance generated by the first RX lines RX1 in the fingerprint area 112 are reduced. In addition, the fingerprint area 112 does not include any of the second RX lines RX2, and thus the sensed parasitic capacitance and the sensed parasitic resistance generated by the second RX lines RX2 in the fingerprint area 112 is prevented. To sum up, the sensed parasitic capacitance and the sensed parasitic resistance generated in the fingerprint area 112 is reduced, thereby preventing the sensed parasitic capacitance and the sensed parasitic resistance from affecting the sensed fingerprint information. Further, due to a length of trace of each of the first RX lines RX1 used for recognizing the fingerprint is reduced, the loading of the controller IC 130 for driving the fingerprint area 112 is also reduced.

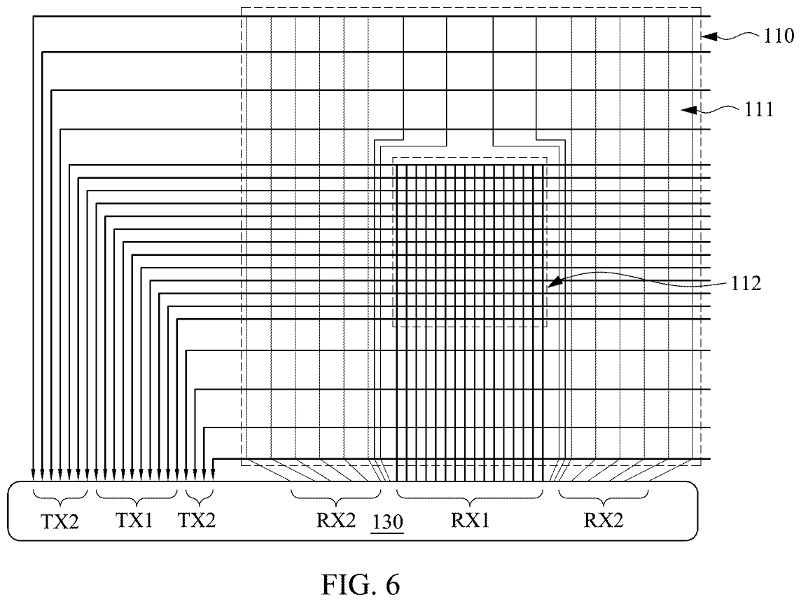

FIG. 6 illustrates a plan view of a layout of the touch area 111 and the fingerprint area 112 of the touchpad 110 of the apparatus 100 according to a fourth embodiment of the present invention.

The layout of the touch area 111 and the fingerprint area 112 as shown in FIG. 6 is similar to the layout of the touch area 111 and the fingerprint area 112 as shown in FIG. 5. However, in the fourth embodiment of the present invention, as shown in FIG. 6, the fingerprint area 112 is located at a middle of the touch pad 110. As shown in FIG. 6, the bottom middle part of the touch area 111 further includes the first RX lines RX1 crossing some of the second TX lines TX2.

As shown in FIG. 6, each of the first RX lines RX1 extends from the controller IC 130 across the fingerprint area 112 and terminates at an upper edge of the fingerprint area 112. In the fourth embodiment of the present invention, each of the first RX lines RX1 terminates at the upper edge of the fingerprint area 112 and does not extend upward to the touch area 111, such that a length of trace of each of the first RX lines RX1 used for recognizing the fingerprint is reduced, and thus the sensed parasitic capacitance and the sensed parasitic resistance generated by the first RX lines RX1 in the fingerprint area 112 are reduced. In addition, the fingerprint area 112 does not include any of the second RX lines RX2, and thus the sensed parasitic capacitance and the sensed parasitic resistance generated by the second RX lines RX2 in the fingerprint area 112 is prevented. To sum up, the sensed parasitic capacitance and the sensed parasitic resistance generated in the fingerprint area 112 is reduced, thereby preventing the sensed parasitic capacitance and the sensed parasitic resistance from affecting the sensed fingerprint information. Further, due to a length of trace of each of the first RX lines RX1 used for recognizing the fingerprint is reduced, the loading of the controller IC 130 for driving the fingerprint area 112 is also reduced.

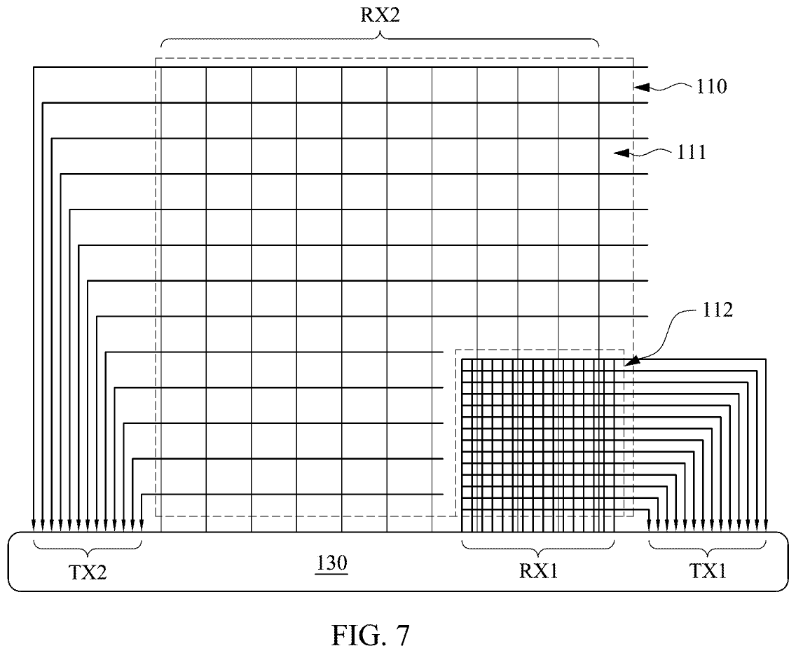

FIG. 7 illustrates a plan view of a layout of the touch area 111 and the fingerprint area 112 of the touchpad 110 of the apparatus 100 according to a fifth embodiment of the present invention.

In the fifth embodiment of the present invention, the fingerprint area 112 includes the first TX lines TX1 cross the first RX lines RX1, and the touch area 111 distinct from the fingerprint area 112 includes the second TX lines TX2 cross the second RX lines RX2.

As shown in FIG. 7, the fingerprint area 112 further includes a portion of the second RX lines RX2 crossing the first TX lines TX1. Each of the second RX lines RX2 included in the fingerprint area 112 is arranged between two adjacent ones of the first RX lines RX1.

The apparatus 100 further includes a controller integrated circuit (IC) 130. The controller IC 130 may supply a driving signal to the sensor through the first/second TX lines TX1/TX2, supply charges to the sensor, and sense changes in capacitance of the sensor through the corresponding RX lines (i.e., the first RX lines RX1 or the second RX lines RX2) in synchronization with the driving signal, thereby sensing a touch input.

In the fifth embodiment of the present invention, when the apparatus 100 is operated in a fingerprint sensing mode, the controller IC 130 supplies the driving signal to the first TX lines TX1, and senses a change in charges of the corresponding sensors input from the first RX lines RX1, and thus determines a fingerprint input, thereby sensing a fingerprint information.

In the fifth embodiment of the present invention, when the apparatus 100 is operated in a touch sensing mode, the controller IC 130 supplies the driving signal to the second TX lines TX2 and a portion of the first TX lines TX1, and senses a change in charges of the corresponding sensors input from the second RX lines RX2, and thus determines a touch input, thereby sensing a touch position.

As shown in FIG. 7, a distance between adjacent ones of the first TX lines TX1 is smaller than a distance between adjacent ones of the second TX lines TX2, and a distance between adjacent ones of the first RX lines RX1 is smaller than a distance between adjacent ones of the second RX lines RX2, and a distance between adjacent ones of the first TX lines TX1 which belong to the portion of the first TX lines TX1 is the same as a distance between adjacent ones of the second TX lines TX2.

As shown in FIG. 7, the fingerprint area 112 is located at a corner of the touchpad 110. As shown in FIG. 7, each of the first RX lines RX1 extends from the controller IC 130 across the fingerprint area 112 and terminates at an upper edge of the fingerprint area 112, and each of the first TX lines RX1 extends from the controller IC 130 across the fingerprint area 112 and terminates at a left edge of the fingerprint area 112. The upper edge of the fingerprint area 112 is perpendicular to the left edge of the fingerprint area 112. In the fifth embodiment of the present invention, each of the first RX lines RX1 terminates at the upper edge of the fingerprint area 112 and does not extend upward to the touch area 111, and each of the first TX lines TX1 terminates at the left edge of the fingerprint area 112 and does not extend leftward to the touch area 111, such that a length of trace of each of the first RX lines RX1 and the first TX lines TX1 used for recognizing the fingerprint is reduced, and thus the sensed parasitic capacitance and the sensed parasitic resistance generated by the first RX lines RX1 and the first TX lines TX1 in the fingerprint area 112 are reduced, thereby preventing the sensed parasitic capacitance and the sensed parasitic resistance from affecting the sensed fingerprint information. Further, due to a length of trace of each of the first RX lines RX1 and the first TX lines TX1 used for recognizing the fingerprint is reduced, the loading of the controller IC 130 for driving the fingerprint area 112 is also reduced.

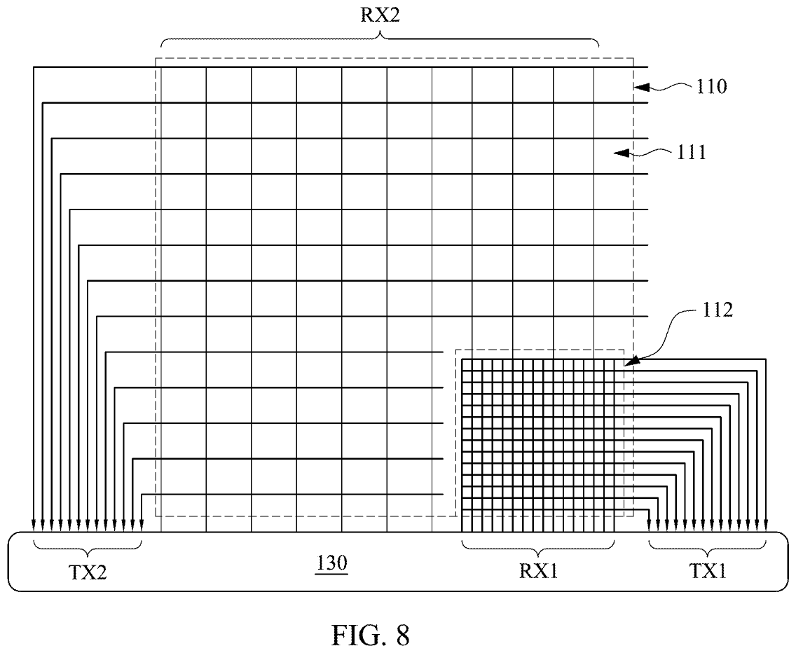

FIG. 8 illustrates a plan view of a layout of the touch area 111 and the fingerprint area 112 of the touchpad 110 of the apparatus 100 according to a sixth embodiment of the present invention.

The layout of the touch area 111 and the fingerprint area 112 as shown in FIG. 8 is similar to the layout of the touch area 111 and the fingerprint area 112 as shown in FIG. 7. However, in the sixth embodiment of the present invention, when the apparatus 100 is operated in a fingerprint sensing mode, the controller IC 130 supplies a driving signal to the first TX lines TX1, and senses a change in charges of the corresponding sensors input from the second RX lines RX2 included in the fingerprint area 112 and the first RX lines RX1, and thus determines a fingerprint input, thereby sensing a fingerprint information. That is, in the sixth embodiment of the present invention, the second RX lines RX2 included in the fingerprint area 112 and the first RX lines RX1 are used for recognizing the fingerprint.

As shown in FIG. 8, the fingerprint area 112 is located at a corner of the touchpad 110. As shown in FIG. 8, each of the first RX lines RX1 extends from the controller IC 130 across the fingerprint area 112 and terminates at an upper edge of the fingerprint area 112, and each of the first TX lines TX1 extends from the controller IC 130 across the fingerprint area 112 and terminates at a left edge of the fingerprint area 112. In the sixth embodiment of the present invention, each of the first RX lines RX1 terminates at the upper edge of the fingerprint area 112 and does not extend upward to the touch area 111, and each of the first TX lines TX1 terminates at the left edge of the fingerprint area 112 and does not extend leftward to the touch area 111, such that a length of trace of each of the first RX lines RX1 and the first TX lines TX1 used for recognizing the fingerprint is reduced, and thus the sensed parasitic capacitance and the sensed parasitic resistance generated in the fingerprint area 112 are reduced, thereby preventing the sensed parasitic capacitance and the sensed parasitic resistance from affecting the sensed fingerprint information. Further, due to a length of trace of each of the first RX lines RX1 and the first TX lines TX1 used for recognizing the fingerprint is reduced, the loading of the controller IC 130 for driving the fingerprint area 112 is also reduced.

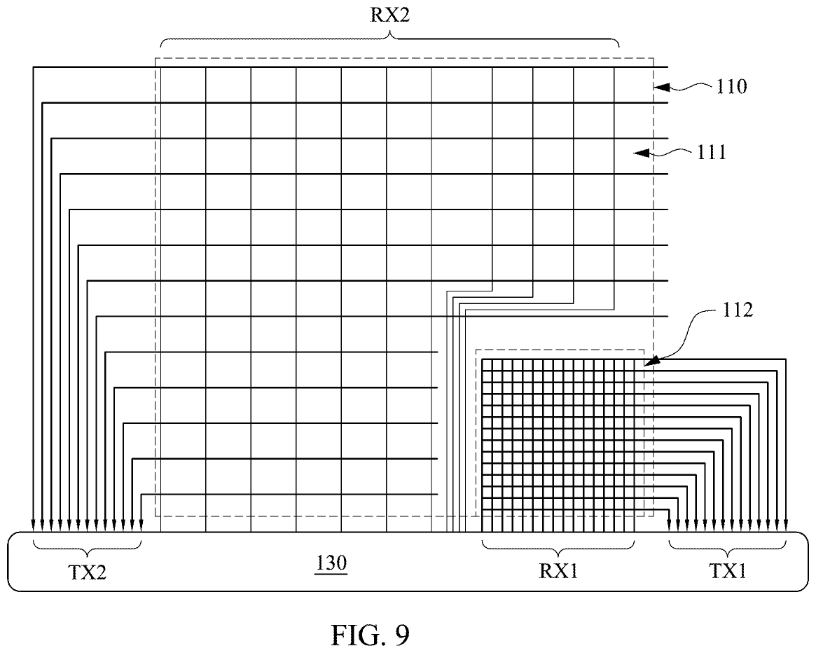

FIG. 9 illustrates a plan view of a layout of the touch area 111 and the fingerprint area 112 of the touchpad 110 of the apparatus 100 according to a seventh embodiment of the present invention.

The layout of the touch area 111 and the fingerprint area 112 as shown in FIG. 9 is similar to the layout of the touch area 111 and the fingerprint area 112 as shown in FIG. 7. However, in the seventh embodiment of the present invention, the fingerprint area 112 does not include any of the second RX lines RX2. Accordingly, each of the second RX lines RX2 of a portion of the second RX lines RX2 extends from the controller IC 130 across the touch area 111 along a left edge and the upper edge of the fingerprint area 112 and terminates at an upper edge of the touch area 111. The left edge of the fingerprint area 112 is perpendicular to the upper edge of the fingerprint area 112.

In the seventh embodiment of the present invention, when the apparatus 100 is operated in a fingerprint sensing mode, the controller IC 130 supplies the driving signal to the first TX lines TX1, and senses a change in charges of the corresponding sensors input from the first RX lines RX1, and thus determines a fingerprint input, thereby sensing a fingerprint information.

In the seventh embodiment of the present invention, when the apparatus 100 is operated in a touch sensing mode, the controller IC 130 supplies a driving signal to the second TX lines TX2 and a portion of the first TX lines TX1, and senses a change in charges of the corresponding sensors input from the second RX lines RX2 and a portion of the first RX lines RX1, and thus determines a touch input, thereby sensing a touch position.

In the seventh embodiment of the present invention, because touch event recognition does not require a definition as high as that of fingerprint recognition, the portion of the first TX lines TX1 used for touch event recognition are selected from the first TX lines TX1, and the first TX lines TX1 which belong to the portion of the first TX lines TX1 used for touch event recognition are selected as the low-density arrangement pattern which is identical to the low-density arrangement pattern of the second TX lines TX2. In the seventh embodiment of the present invention, because touch event recognition does not require a definition as high as that of fingerprint recognition, the portion of the first RX lines RX1 used for touch event recognition are selected from the first RX lines RX1, and the first RX lines RX1 which belong to the portion of the first RX lines RX1 used for touch event recognition are selected as the low-density arrangement pattern which is identical to the low-density arrangement pattern of the second RX lines RX2. In the seventh embodiments of the present invention, a distance between adjacent ones of the first TX lines TX1 which belong to the portion of the first TX lines TX1 is the same as a distance between adjacent ones of the second TX lines TX2, and a distance between adjacent ones of the first RX lines RX1 which belong to the portion of the first RX lines RX1 is the same as a distance between adjacent ones of the second RX lines RX2.

As shown in FIG. 9, the fingerprint area 112 is located at a corner of the touchpad 110. As shown in FIG. 9, each of the first RX lines RX1 extends from the controller IC 130 across the fingerprint area 112 and terminates at an upper edge of the fingerprint area 112, and each of the first TX lines TX1 extends from the controller IC 130 across the fingerprint area 112 and terminates at a left edge of the fingerprint area 112. In the seventh embodiment of the present invention, each of the first RX lines RX1 terminates at the upper edge of the fingerprint area 112 and does not extend upward to the touch area 111, and each of the first TX lines TX1 terminates at the left edge of the fingerprint area 112 and does not extend leftward to the touch area 111, such that a length of trace of each of the first RX lines RX1 and the first TX lines TX1 used for recognizing the fingerprint is reduced, and thus the sensed parasitic capacitance and the sensed parasitic resistance generated by the first RX lines RX1 and the first TX lines TX1 in the fingerprint area 112 are reduced. In addition, the fingerprint area 112 does not include any of the second RX lines RX2, and thus the sensed parasitic capacitance and the sensed parasitic resistance generated by the second RX lines RX2 in the fingerprint area 112 is prevented. To sum up, the sensed parasitic capacitance and the sensed parasitic resistance generated in the fingerprint area 112 is reduced, thereby preventing the sensed parasitic capacitance and the sensed parasitic resistance from affecting the sensed fingerprint information. Further, due to a length of trace of each of the first RX lines RX1 and the first TX lines TX1 used for recognizing the fingerprint is reduced, the loading of the controller IC 130 for driving the fingerprint area 112 is also reduced.

From the above description, the present invention provides an apparatus 100 integrated with fingerprint recognition and touch detection. The touchpad 110 of the apparatus 100 of the present invention can both perform touch event recognition and fingerprint recognition, and therefore the apparatus 100 of the present invention does not require an addition separate fingerprint recognition device, thereby reducing cost and complexity of operating the apparatus, and such that the appearance of the apparatus of the present invention is simple and generous. Further, the touchpad 110 of the apparatus 100 of the present invention reduces the sensed parasitic capacitance and the sensed parasitic resistance generated in the fingerprint area, thereby preventing the sensed parasitic capacitance and the sensed parasitic resistance from affecting the sensed fingerprint information.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. An apparatus integrated with fingerprint recognition and touch detection, comprising:
a touchpad having a touch area for recognizing a touch event and a fingerprint area for recognizing a fingerprint and the touch event, wherein the fingerprint area includes first receive (RX) lines crossing first transmit (TX) lines, wherein the touch area includes second RX lines crossing the first TX lines and second TX lines; and
a controller integrated circuit (IC), wherein each of the first RX lines extends from the controller IC across the fingerprint area and terminates at a first edge of the fingerprint area;
wherein the fingerprint area further includes a portion of the second RX lines crossing the first TX lines;
wherein each of the second RX lines included in the fingerprint area is arranged between adjacent ones of the first RX lines.

2. The apparatus integrated with fingerprint recognition and touch detection of claim 1,
wherein a distance between adjacent ones of the first TX lines is smaller than a distance between adjacent ones of the second TX lines;
wherein a distance between adjacent ones of the first RX lines is smaller than a distance between adjacent ones of the second RX lines.

3. (canceled)

4. The apparatus integrated with fingerprint recognition and touch detection of claim 1,
wherein when the apparatus is operated in a touch sensing mode, the controller IC supplies a driving signal to the second TX lines and a portion of the first TX lines, such that the touch event is recognized according to changes in capacitance sensed through the second RX lines;
wherein a distance between adjacent ones of the first TX lines which belong to the portion of the first TX lines is the same as a distance between adjacent ones of the second TX lines.

5. The apparatus integrated with fingerprint recognition and touch detection of claim 1,
wherein when the apparatus is operated in a fingerprint sensing mode, the controller IC supplies a driving signal to the first TX lines, such that the fingerprint is recognized according to changes in capacitance sensed through the first RX lines.

6. The apparatus integrated with fingerprint recognition and touch detection of claim 1,
wherein when the apparatus is operated in a fingerprint sensing mode, the controller IC supplies a driving signal to the first TX lines, such that the fingerprint is recognized according to changes in capacitance sensed through the second RX lines included in the fingerprint area and the first RX lines.

7-10. (canceled)

11. An apparatus integrated with fingerprint recognition and touch detection, comprising:
a touchpad having a touch area for recognizing a touch event and a fingerprint area for recognizing a fingerprint and the touch event, wherein the fingerprint area includes first receive (RX) lines crossing first transmit (TX) lines, wherein the touch area includes second RX lines crossing second TX lines; and
a controller integrated circuit (IC), wherein each of the first RX lines extends from the controller IC across the fingerprint area and terminates at a first edge of the fingerprint area, wherein each of the first TX lines extends from the controller IC across the fingerprint area and terminates at a second edge of the fingerprint area;
wherein the fingerprint area further includes a portion of the second RX lines crossing the first TX lines;
wherein each of the second RX lines included in the fingerprint area is arranged between adjacent ones of the first RX lines.

12. The apparatus integrated with fingerprint recognition and touch detection of claim 11, wherein the fingerprint area is located at a corner of the touch pad.

13. The apparatus integrated with fingerprint recognition and touch detection of claim 11,
wherein a distance between adjacent ones of the first TX lines is smaller than a distance between adjacent ones of the second TX lines;
wherein a distance between adjacent ones of the first RX lines is smaller than a distance between adjacent ones of the second RX lines.

14. (canceled)

15. The apparatus integrated with fingerprint recognition and touch detection of claim 11,
wherein when the apparatus is operated in a touch sensing mode, the controller IC supplies a driving signal to the second TX lines and a portion of the first TX lines, such that the touch event is recognized according to changes in capacitance sensed through the second RX lines;
wherein a distance between adjacent ones of the first TX lines which belong to the portion of the first TX lines is the same as a distance between adjacent ones of the second TX lines.

16. The apparatus integrated with fingerprint recognition and touch detection of claim 11,
wherein when the apparatus is operated in a fingerprint sensing mode, the controller IC supplies a driving signal to the first TX lines, such that the fingerprint is recognized according to changes in capacitance sensed through the first RX lines.

17. The apparatus integrated with fingerprint recognition and touch detection of claim 11,
wherein when the apparatus is operated in a fingerprint sensing mode, the controller IC supplies a driving signal to the first TX lines, such that the fingerprint is recognized according to changes in capacitance sensed through the second RX lines included in the fingerprint area and the first RX lines.

18. The apparatus integrated with fingerprint recognition and touch detection of claim 11,
wherein a portion of the second RX lines extends from the controller IC across the touch area along the first edge and the second edge of the fingerprint area and terminates at an edge of the touch area;
wherein the first edge of the fingerprint area is perpendicular to the second edge of the fingerprint area.

19. The apparatus integrated with fingerprint recognition and touch detection of claim 18,
wherein when the apparatus is operated in a touch sensing mode, the controller IC supplies a driving signal to the second TX lines and a portion of the first TX lines, such that the touch event is recognized according to changes in capacitance sensed through the second RX lines and a portion of the first RX lines;
wherein a distance between adjacent ones of the first TX lines which belong to the portion of the first TX lines is the same as a distance between adjacent ones of the second TX lines;
wherein a distance between adjacent ones of the first RX lines which belong to the portion of the first RX lines is the same as a distance between adjacent ones of the second RX lines which do not belong to the portion of the second RX lines.

20. The apparatus integrated with fingerprint recognition and touch detection of claim 18,
wherein when the apparatus is operated in a fingerprint sensing mode, the controller IC supplies a driving signal to the first TX lines, such that the fingerprint is recognized according to changes in capacitance sensed through the first RX lines.

21. An apparatus integrated with fingerprint recognition and touch detection, comprising:
a touchpad having a touch area for recognizing a touch event and a fingerprint area for recognizing a fingerprint and the touch event, wherein the fingerprint area includes first receive (RX) lines crossing first transmit (TX) lines, wherein the touch area includes second RX lines crossing the first TX lines and second TX lines; and
a controller integrated circuit (IC), wherein each of the first RX lines extends from the controller IC across the fingerprint area and terminates at a first edge of the fingerprint area;
wherein the fingerprint area is located at a center of the touch pad;
wherein the touch area further includes the first RX lines crossing a portion of the second TX lines.

22. The apparatus integrated with fingerprint recognition and touch detection of claim 21,
wherein a portion of the second RX lines extends from the controller IC across the touch area along the first edge, a second edge, and a third edge of the fingerprint area and terminates at an edge of the touch area;
wherein the second edge and the third edge of the fingerprint area are perpendicular to the first edge of the fingerprint area.

23. The apparatus integrated with fingerprint recognition and touch detection of claim 22,
wherein when the apparatus is operated in a touch sensing mode, the controller IC supplies a driving signal to the second TX lines and a portion of the first TX lines, such that the touch event is recognized according to changes in capacitance sensed through the second RX lines and a portion of the first RX lines;
wherein a distance between adjacent ones of the first TX lines which belong to the portion of the first TX lines is the same as a distance between adjacent ones of the second TX lines;
wherein a distance between adjacent ones of the first RX lines which belong to the portion of the first RX lines is the same as a distance between adjacent ones of the second RX lines which do not belong to the portion of the second RX lines.

24. The apparatus integrated with fingerprint recognition and touch detection of claim 22,
wherein when the apparatus is operated in a fingerprint sensing mode, the controller IC supplies a driving signal to the first TX lines, such that the fingerprint is recognized according to changes in capacitance sensed through the first RX lines.
